(19) United States
(12) Patent Application Publication
(10) Pub. No.: US 2007/0237102 A1
(43) Pub. Date: Oct. 11, 2007

(54) System and method for transferring data to and from mobile devices

(76) Inventor: Gary R. Trott, San Mateo, CA (US)

Correspondence Address: Kathy Manke;Avago Technologies Limited, 4380 Ziegler Road, Fort Collins, CO, 80525, US

(21) Appl. No.: 11/399,892

(22) Filed: Apr. 7, 2006

(51) Int. Cl. H04B 7/00

(52) U.S. Cl. 370/310

(57) ABSTRACT

Mobile devices, such as cameras and cellular telephones, can be equipped with a high-speed low power system for transferring data to a commonly available intermediary receiver. The intermediary receiver would then transfer the received data into a computer for storage or subsequent processing. In one embodiment, the commonly available receiver would be a peripheral device to the computer, such as the computer's keyboard or mouse, which is linked to the PC by cable or wirelessly. The link between the receiver and the mobile device would be, for example, an infrared data (IrDA) link.

### TECHNICAL FIELD

This disclosure relates to data transfer and more particularly to systems and methods for transferring data to and from mobile devices.

### BACKGROUND OF THE INVENTION

The memory capacity of mobile devices, such as cellular telephones and digital cameras, is continuously increasing. This memory may be used to capture and hold digital data, such as digitally captured photos, music, calendars, contact lists, sophisticated games, etc. The quantity of data should in such devices has, or is about to, reach the point where the transfer rate of ordinary voice data path connections becomes too slow to conveniently handle data transfers to and from the mobile device. Compounding the problem is that mobile devices are now being used for financial transactions using IrDA transceivers for secure, local, point of sale communications. Thus, not only is speed important, but in some applications security is critical.

One method to accomplish high speed data transfer is to use an electrical transfer. This could be in the form of an electrical plug and wire, such as is done on existing serial ports. Alternatively, a flash memory device could be used to transfer the data. Both of these methods require active participation of the user, and are time consuming thereby inhibiting the graceful exchange of data.

Another example of the transfer would be to use a higher data rate wireless communication path, such as Bluetooth or Wi-Fi. In principle these would work, but because of the omnidirectional nature of wireless transmission, care would have to be given to security issues and battery life of the mobile device.

### BRIEF SUMMARY OF THE INVENTION

Mobile devices, such as cameras and cellular telephones, can be equipped with a high-speed low power system for transferring data to a commonly available intermediary receiver. The intermediary receiver would then transfer the received data into a computer for storage or subsequent processing. In one embodiment, the commonly available receiver would be a peripheral device to the computer, such as the computer's keyboard or mouse, which is linked to the PC by cable or wirelessly. The link between the receiver and the mobile device would be, for example, an infrared data (IrDA) link.

### BRIEF DESCRIPTION OF THE DRAWINGS

FIG. 1 shows one embodiment of a system using an intermediary receiver in the form of a computer input device; and

FIG. 2 shows an alternate intermediary receiver.

### DETAILED DESCRIPTION OF THE INVENTION

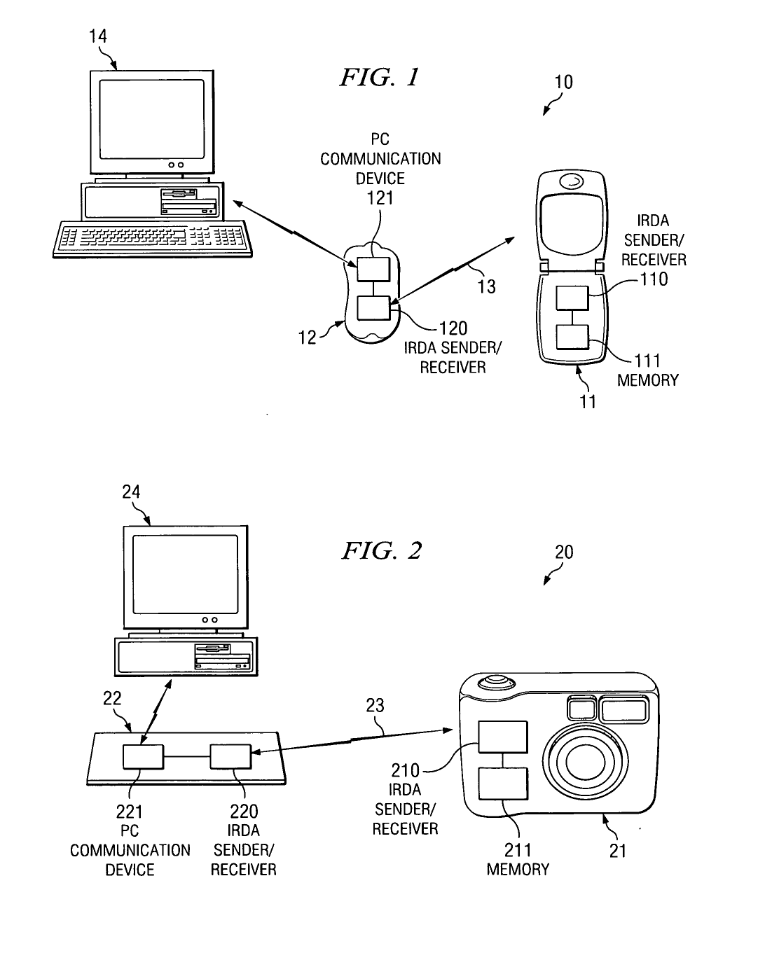

FIG. 1 shows one embodiment 10 of a system where mobile device 11 stores data therein. The data which is memory 111 from time to time is transferred to sender/receiver 110 for transmission over a communication link, such as communication link 13, to an intermediary device, such as device 12, via sender/receiver 120. In FIG. 1, the intermediary device is a “mouse” (a pointer) in communication with PC 14 via PC communication device 121. Pointer 12 is permanently associated with PC 14 such that a user can use the mouse as desired for controlling input to the computer. This association may be by a wire line or wireless communication link, and while permanent may be disassociated from time to time. These links can be IrDA, Bluetooth, Wi-Fi, and/or wideband RF.

Intermediate device 12, as shown in FIG. 1, is a mouse pointer whereas as shown in FIG. 2, intermediate device 22 is a key pad. Any other peripheral device which is at least temporarily in communication with PC 14 (FIG. 1) or PC 24 (FIG. 2), can be used. Preferably, the intermediate device is used to interface with the computer for purposes other than to transfer data to/from devices 11, 12. The intermediate device ideally would be a device commonly associated with the PC and for ease of data transfer it would normally reside in user space around the PD and not in the back of the PC under a tangle of wires. Since keyboards and mice are normally positioned in the user space while a display would be on top of the desk or PC also in user space. Phones, printers, and headsets would be typical intermediate devices.

As shown in FIGS. 1 and 2 the communication link between the intermediate device and the mobile device is an IrDA device but it can be any type of wireless device having high speed and relative security between the mobile device and the intermediary device. The transfer of data from the mobile device to the intermediating device can occur anytime the IrDA units of the two devices are lined up.

A PC or a processor, such as computer 14, FIG. 1, can be described as a “point of presence” with larger storage and functionality and communication options than that associated with a mobile device. Because it has a larger storage capacity it is usually maintained at a specific location in a home, office or vehicle. The user transfers the data from the mobile unit because the electronic resources and available operations are larger in the point of presence. The mobile device can be anything carried by a person, on a person, or in a person such as biomedical instrumentation or a drug delivery unit. The PC, or point of presence, could be part of, or embedded in, an entertainment system or in a measurement system or building factory automation system. In such a point of presence, the functionality may be sound or video editing, speed of calculation, larger information displays or communication with remote host servers.

The user typically uses the intermediate device to transfer large amounts of data quickly, easily, and securely between the mobile device and the point of presence using an intermediate device located in the user's space and connected to the feature rich set on the point of presence. However, two-way communication or control might ensue based on the application between the point of presence and the mobile device through the intermediate device. For example, a heads-up headset and viewer might be in continuous two-way communication with the point of presence via the intermediate device.

FIG. 2 shows an alternate arrangement having keyboard 22 as the intermediate device between PC 24 and mobile device 21. In this embodiment mobile device 21 is a camera having memory 211 in communication internally with sender/receiver 210 which in turn communicates to intermediate device 22 over communication link 23 to sender/receiver 220 within the intermediate device. PC communication device 221 then passes the communication to/from PC 24. Again as in FIG. 1, intermediate device 22 is permanently associated with PC 24 although it can be removed from time to time if desired. When it is removed then mobile device 21 will have to communicate if at all with PC 24 through a different intermediate device, such as intermediate device 12.

Note that while only one intermediate device is shown in each of FIGS. 1 and 2, several intermediate devices can be utilized at the same time such that mobile device 11 or 21 can come into proximity to device 12 or device 22 for the transfer of information back and forth between the PC and the mobile device. Devices 12 and 22 are peripheral devices associated with their respective PC's and mobile devices 11 and 21 are independent from peripheral devices 12 and 22 and only come into proximity therewith occasionally. The mobile device can be, for example, cellular telephones, digital cameras, camcorders, PDAs, watches, global positioning devices, heads-up headset displays, electronic wallets, biomedical instrument/monitors, and/or drug delivery units.

Although the present invention and its advantages have been described in detail, it should be understood that various changes, substitutions and alterations can be made herein without departing from the spirit and scope of the invention as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

What is claimed is:

1. A method for data transfer between a mobile device and a point of presence device, said method comprising;
bringing a mobile device into proximity with an intermediate device, said intermediate device in communication with said point of presence device; and
transferring data to or from said mobile device through said intermediate device to said data processing device.

2. The method of claim 1 wherein said intermediate device is selected from the list of: keyboard, pointing device, monitor, phone, printer, headset, and other PC peripherals normally accessible to people in the vicinity of a point of presence or PC.

3. The method of claim 2 wherein said transferring is by a high-speed temporarily established communication connection.

4. The method of claim 3 wherein said communication connection to said intermediate device is selected from the list of: IrDA, Bluetooth, Wi-Fi, and wideband RF.

5. The method of claim 3 wherein said communication connection comprises:
a pre-established validation between said mobile device and said intermediate device.

6. The method of claim 2 wherein said mobile device is selected from the list of:
cellular telephones, digital cameras, camcorders, PDAs, watches, global positioning devices, heads-up headset displays, electronic wallets, biomedical instrument/monitors, and/or drug delivery units.

7. A mobile device comprising:
a memory for storing data; and
a wireless data transfer algorithm for communicating with a point of presence device through a device which is peripheral to said point of presence device and permanently associated with said point of presence device.

8. The device of claim 7 wherein said peripheral device communicates with said point of presence to perform functions other than said communication between said mobile device and said point of presence.

9. The device of claim 8 wherein said data transfer is via an IrDA link between said mobile device and said point of presence.

10. The device of claim 8 wherein said peripheral device is selected from the list of: cellular telephones, digital cameras, camcorders, PDAs, watches, global positioning devices, heads-up headset displays, electronic wallets, biomedical instrument/monitors, and/or drug delivery units.

11. The device of claim 8 wherein said other functions are selected from the list of: data storage, calculating data, video editing, audio editing and/or communications.

12. The device of claim 8 wherein said mobile device is selected from the list of:
cellular telephones, digital cameras, camcorders, PDAs, watches, global positioning devices, heads-up headset displays, electronic wallets, biomedical instrument/monitors, and/or drug delivery units.

13. A peripheral device for communication with a computer, said device comprising:
means for communicating functions between a user of said computer and said computer;
means for communicating with mobile devices other than said computer; and
wherein said computer communicating means is further operable for passing communications received from said mobile device to said computer.

14. The device of claim 13 wherein said functions are input functions obtained from said user.

15. The device of claim 13 wherein said mobile device communicating means comprises an IrDA link.

16. The device of claim 13 wherein said computer communicating means is further operable for passing communications to said mobile device from said computer.

17. A data transfer system comprising:
a point of presence;
a peripheral device in communication with said point of presence, said peripheral device comprising;
a communication path for communicating commands from a user to said point of presence; and
said data transfer system further comprising:
a mobile device comprising;
a memory for storing data therein; and
a data link to said peripheral device, said data link operable for transferring data between said mobile device memory and said peripheral device; and
wherein said peripheral device is operable for communicating data received from said mobile device to said point of presence over said communication path.

18. The system of claim 17 wherein said data link is selected from the list of IrDA, Bluetooth, Wi-Fi, and wideband RF.

19. The system of claim 17 wherein said point of presence communicates data to said mobile device through said peripheral device.

20. The system of claim 17 wherein said peripheral device is selected from the list of: cellular telephones, digital cameras, camcorders, PDAs, watches, global positioning devices, heads-up headset displays, electronic wallets, biomedical instrument/monitors, and/or drug delivery units.
